(19) United States
(12) Patent Application Publication
(10) Pub. No.: US 2023/0398651 A1
(43) Pub. Date: Dec. 14, 2023

(54) Machine Concept for the Mass Production of High-Precision Workpieces

(71) Applicant: Imoberdorf Holding AG, Oensingen (CH)

(72) Inventors: Attila Barbetta, Thorigen (CH); Anton Imoberdorf, Feldbrunnen (CH)

(73) Assignee: Imoberdorf Holding AG, Oensingen (CH)

(21) Appl. No.: 18/035,636

(22) PCT Filed: Nov. 11, 2021
(86) PCT No.: PCT/CH2021/000003

§ 371 Date: May 5, 2023

(30) Foreign Application Priority Data
Nov. 12, 2020 (EP) 20405024.9

(51) Int. Cl. B23Q 7/14; B23Q 37/00; B23Q 41/02

(52) U.S. Cl. CPC B23Q 7/14; B23Q 37/007; B23Q 41/02

(57) ABSTRACT

A machine concept for the mass production of high-precision workpieces, with increased quantity of workpieces to be produced within a defined time including at least one machining center is equipped with the required machining units (2) which are directed toward a common machining region. The specification and arrangement of the machining units used and the technological machining sequence are optimized relative to the workpiece characteristic. These production conditions are fixed as validated after an audit. In order to produce a second target value of the quantity of workpieces to be produced within the defined time unit, which second value is increased in relation to the first target value, at least one further machining center is added to the at least one machining center while maintaining the validated production conditions.

### FIELD OF THE INVENTION

The present invention relates to a machine concept for the mass production of high-precision workpieces, comprising a perspective increase in the quantity of workpieces to be produced within a defined time unit. By way of example, workpieces are gear parts for the manufacture of automobiles or parts for medical technology, namely from branches of industry with high guarantee conditions for the parts produced.

### PRIOR ART

Until now, conventional machine concepts for the mass production of high-precision workpieces from blanks, for example by turning, grinding, boring, milling or thread cutting, were based on the use of standard machines. In addition to the specification of the material for the blanks, the machines and tools used and the production technology are fixed as boundary conditions to be constantly maintained in a so-called validation between the producers of the workpieces and the customer. These boundary conditions generally apply contractually over a lengthy time period and even when the quantities to be produced and delivered are increased. If the required quantity is increased, and the existing machines were previously used to capacity and the validation maintained, as a consequence the manufacturer has only the option of correspondingly increasing the number of machines used. Thus the effort in terms of machinery and energy and the space requirement are multiplied, wherein the machines which are used are rarely able to correspond optimally to the machining processes still to be carried out, i.e. are oversized or premature signs of wear have to be remedied. Thus, in spite of increasing the production numbers, neither a reduction in the resources used and the environmental pollution, nor a reduction in the unit costs, is possible.

### OBJECT OF THE INVENTION

In view of the drawbacks set forth in the previously practiced machine concepts for the mass production of high-precision workpieces, in particular with a probable perspective increase in the quantities required, the object of the invention is to provide an improved machine concept. Even with an initial quantity of workpieces to be produced, an optimal use of resources has to be achieved and at the same time the boundary conditions for the mass production, which are fixed in a validation, have to continue to be ensured even in the case of increases in production. Finally, with the improved machine concept, it is necessary to minimize the material and personnel resources to be provided and the resulting environmental pollution, and also as far as possible to reduce the unit costs in the case of increased, in particular multiplied, production numbers.

### OVERVIEW OF THE INVENTION

A machine concept for the mass production of high-precision workpieces, comprising a perspective increase in the quantity of workpieces to be produced within a defined time unit, forms the subject of the present invention. In order to produce a first target value of the quantity of workpieces to be produced within the defined time unit according to the machining steps to be carried out on the workpieces, at least one machining center is equipped with the required machining units which are directed toward a common machining region. The specification and arrangement of the machining units used and the technological machining sequence are optimized relative to the workpiece characteristic. These production conditions are fixed as validated after an audit. In order to produce a second target value of the quantity of workpieces to be produced within the defined time unit, which second value is increased in relation to the first target value, at least one further machining center is added to the at least one machining center while maintaining the validated production conditions. If there has been a significant increase in the demand for, and therefore the target value of, the quantity of workpieces to be produced within the defined time unit, no further machining centers are provided in the machine concept, but the workpiece production is transferred to a transfer machine while maintaining the validated production conditions. In order to maintain the validation, only such machining units are installed on the transfer machine which are equivalent to the specification of the machining units used in the machining centers.

The following features relate to specific embodiments of the invention: The implementation of all of the machining steps to be carried out on a workpiece takes place in the machining region initially of a single machining center under the validated production conditions. Alternatively, with the continued validity of the validated production conditions, in order to increase the quantity of workpieces to be produced, the machine concept is extended by further machining centers. All of the machining steps provided on the workpiece are carried out on each individual machining center or, in a formed production line, the first machining center is designated for carrying out a first sequence of machining steps on the workpiece and the next machining center is designated for carrying out further sequences of machining steps on the workpiece.

When forming a production line with a plurality of machining centers, an interlinked configuration is arranged in series, parallel or combined form. The individual machining centers, respective groups of machining centers or all of the machining centers are assigned with:
one respective transport device, or one transport device used as a whole, which serves for the supply of the workpiece blanks, for the onward transport of partially machined workpieces and for the removal of the fully machined workpieces; and
one respective material chips removing region, or one material removing region used as a whole, which serves for the preparation and removal of the material chips which arise.

Also conceivable is a control system which can be used as a whole.

A plurality of machining units, preferably three machining units, are provided in the machining region, the machining units being able to be used for simultaneous machining on the same workpiece.

The first machining center has a loading and unloading region for supplying the workpiece blanks into the machining region or for removing the partially or fully machined workpiece. The at least one next machining center has a loading and unloading region for supplying a workpiece partially machined on an upstream machining center into the machining region of this next machining center or for removing the partially or fully machined workpiece.

The individual machining unit is based on one respective axis system which permits the movement of the tool guided by the machining unit in the x-y-z coordinate system. When the machining spindle is activated, it rotates about the first axis of rotation, whereby the tool driven by the machining spindle is set in rotation.

The loading and unloading region has a pivoting block with a pivoting head which is rotatable about a pivot axis and which is designed for holding unmachined or partially machined workpieces to be introduced into the machining region or partially or fully machined workpieces to be removed from the machining region. The pivoting head, which is rotatable about the pivot axis, has at least two clamping chucks for holding and for transporting the workpieces. One of the clamping chucks is designated for loading and unloading the workpieces in a first rotational position of the pivoting head, while the other clamping chuck positions the workpieces for machining in the first rotational position, and in the second rotational position of the pivoting head the functions of the two clamping chucks are changed. Moreover, a second axis of rotation extends through the pivoting block in order to set in rotation, as required, the clamping chuck which is respectively currently in the axial direction with the workpiece clamped therein, for example for a turning machining process, or to adjust the clamping chuck in terms of rotational position in order to machine another side of the workpiece.

Inside the machining center at least one of the machining units is assigned a tool changing unit. At least one of the machining units is configured to remove material by cutting and another of the machining units could be provided for picking up a workpiece from a clamping chuck.

In the machine concept, the transfer machine to be provided in the case of very high target values of workpieces to be produced, only perspectively developed, is configured as a rotary transfer machine, a plurality of machining units being installed radially around the centrally arranged rotary frame thereof. The machining units installed on the rotary transfer machine correspond to the machining units hitherto used in the machining centers, so that the validated production conditions continue to be maintained in this regard.

### BRIEF DESCRIPTION OF THE ACCOMPANYING DRAWINGS

In the drawings show:

FIG. 1A—a machining center from the machine concept according to the invention in a perspective basic view;

FIG. 1B—the machining center according to FIG. 1A with a cutout in the protective cladding for viewing into the machining and tool changing region of the machining center;

FIG. 2A—the machining center according to FIG. 1A with the loading and unloading region and machining region thereof consisting of three machining units in a schematic plan view;

FIG. 2B—the construction according to FIG. 2A in a perspective view;

FIG. 2C—the construction according to FIG. 2B in a changed perspective view;

FIG. 2D—the construction according to FIG. 2C with the pivoting head adjusted on the pivoting block of the loading and unloading region;

FIG. 2E—the pivoting block of FIG. 2C with the two clamping chucks arranged on the pivoting head in a perspective basic view;

FIG. 3A—a machining unit of FIG. 2A with the x-y-z axis system and horizontal machining spindle in a perspective basic view;

FIG. 3B—the machining unit according to FIG. 3A with the machining spindle adjusted in the y-direction;

FIG. 3C—the tool holder with the tool fixed therein, removed from the machining spindle in a perspective basic view;

FIG. 4A to 4C—machine concepts with further equipment and a plurality of machining centers;

FIG. 4A—a machining center according to FIG. 1A with an assigned material removing region and robot and an active operator in a schematic plan view;

FIG. 4B—three machining centers linked together with a common material removing region and transport device in a schematic plan view;

FIG. 4C—four machining centers linked together with a material removing region respectively assigned thereto in pairs and a common transport device and a robot in a schematic plan view; and

FIG. 5—a machining unit with the assigned tool changing unit of FIG. 1B in a perspective basic view.

### EXEMPLARY EMBODIMENT

With reference to the accompanying drawings, the detailed description is made below of an exemplary embodiment of the machine concept according to the invention for the mass production of high-precision workpieces, namely for branches of industry with high guarantee conditions for the parts produced.

The entire further description applies as a definition. If reference numerals are contained in a figure for the purpose of illustrative clarity, but not explained in the immediately associated text of the description, reference is made to the explanation thereof in the preceding or following description of the figures.

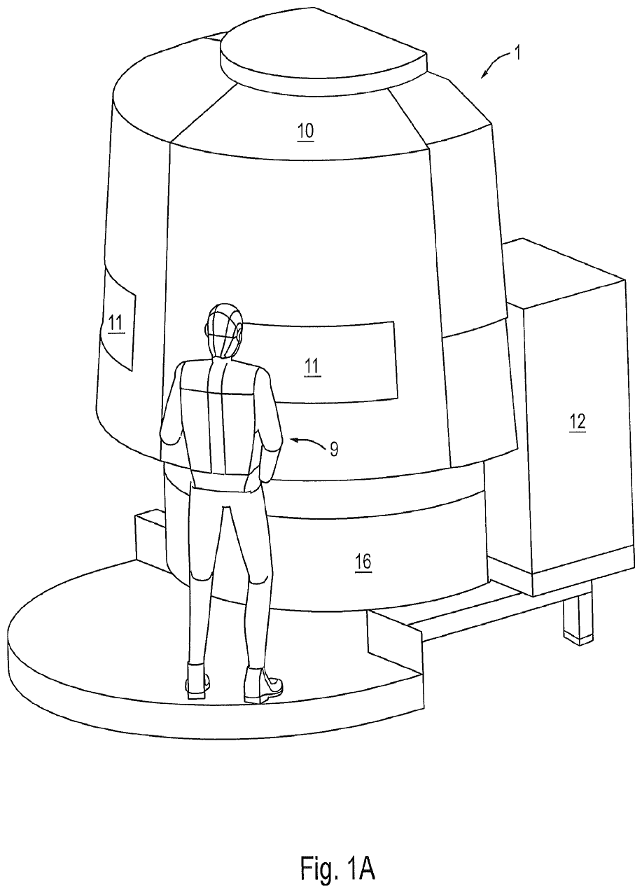

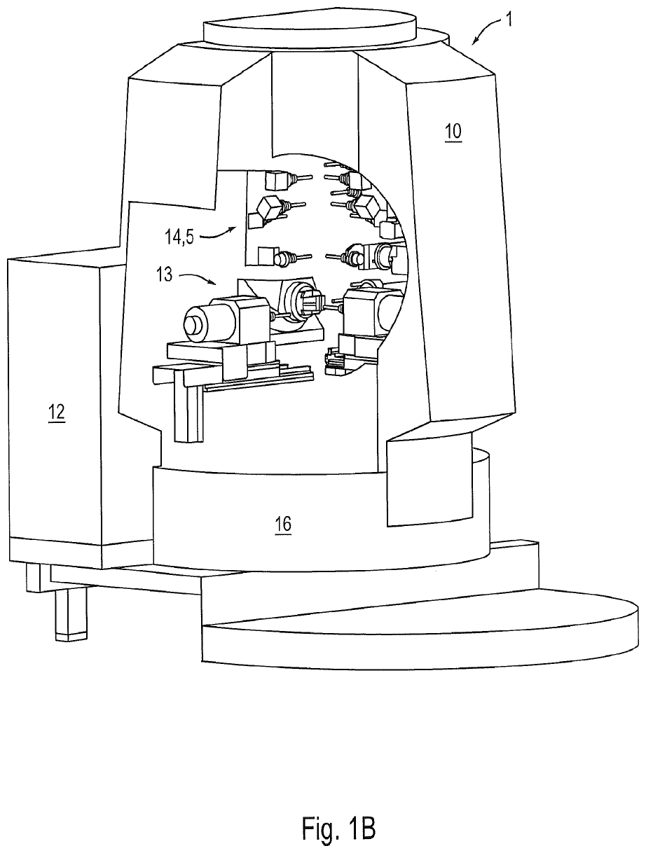

### FIGS. 1A and 1B

For a first, still relatively small, quantity of workpieces 8 to be produced, for example a component for the fuel pump of an automobile, with the target quantity of 200,000 units/year, the machine concept comprises a single machining center 1 which rests on a machine base 16 and which is surrounded by a protective cladding 10 which has a viewing window 11 for an operator 9 to view into the interior of the machining center 1. A control system 12 is provided. The machining region 13 and the optionally present tool changing region 14 with the tool changing unit 5 can be seen through a cutout in the protective cladding 10, which is only present for illustrative purposes.

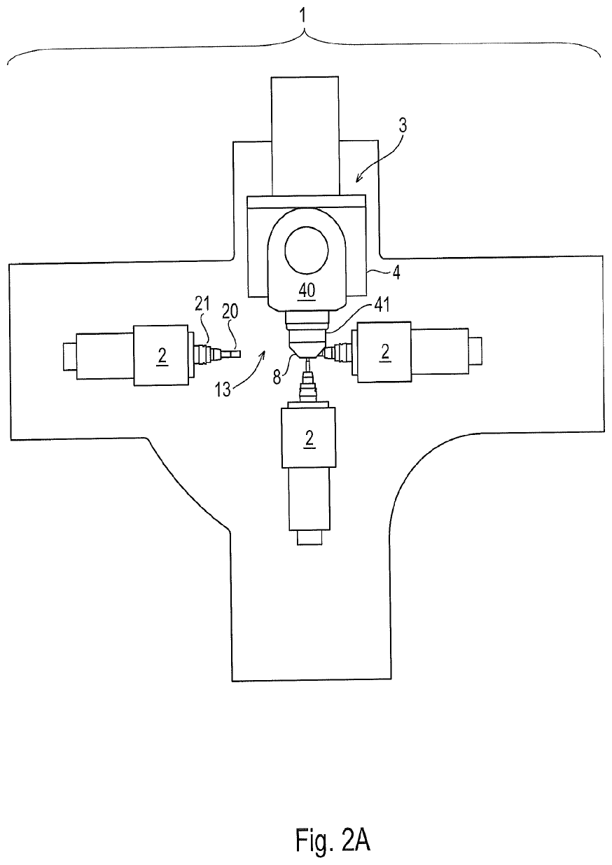

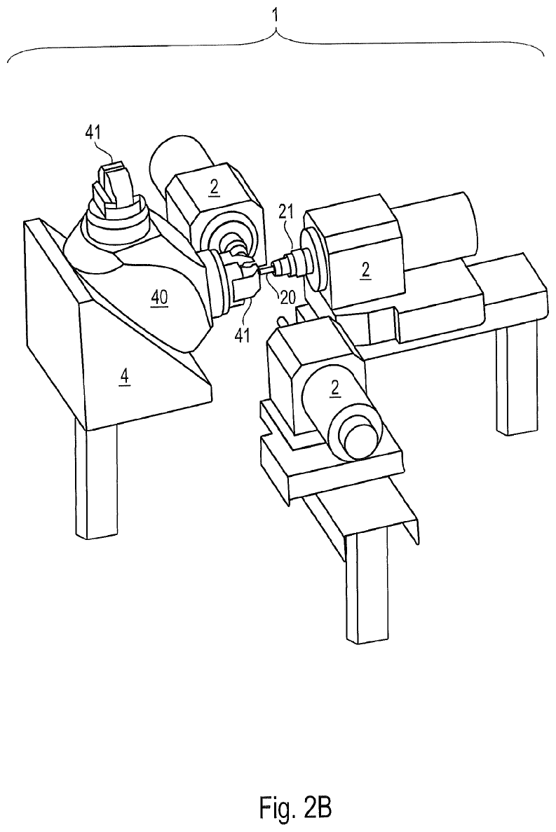

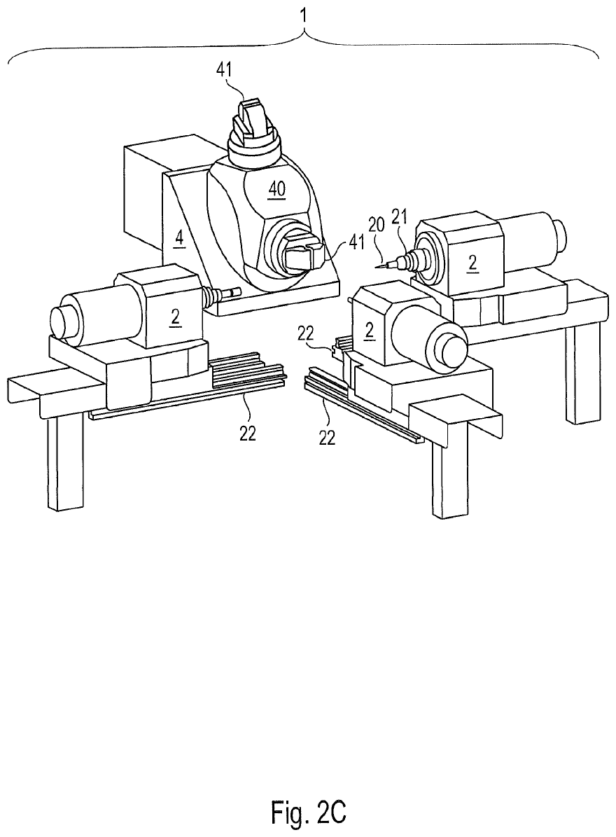

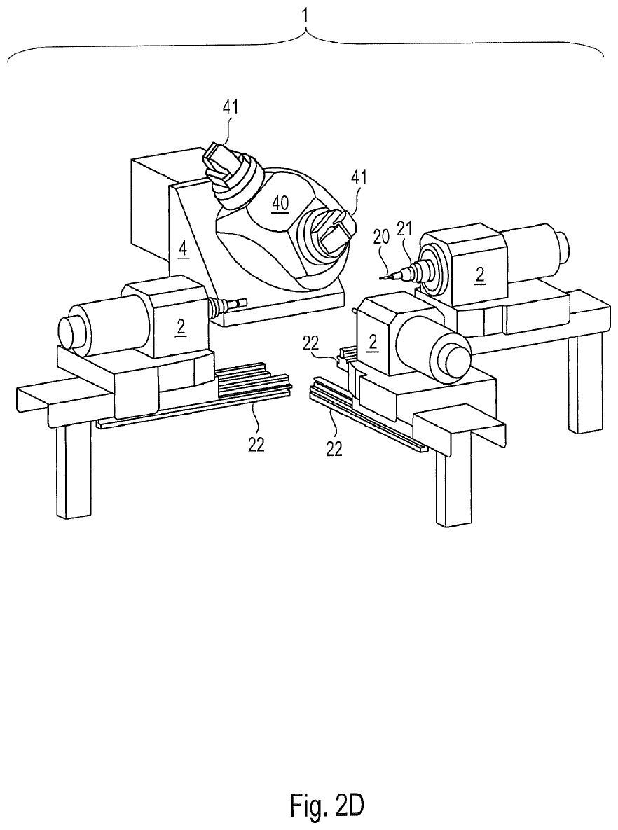

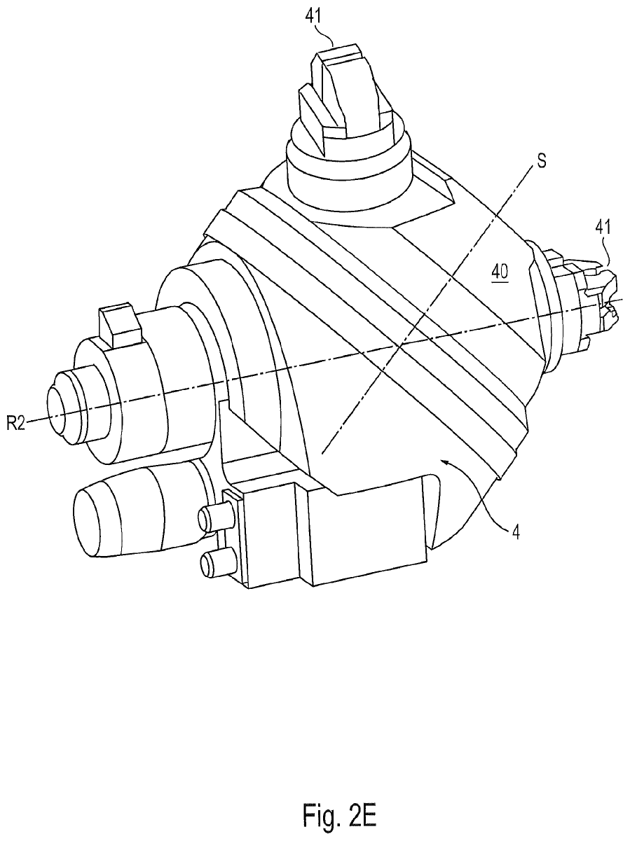

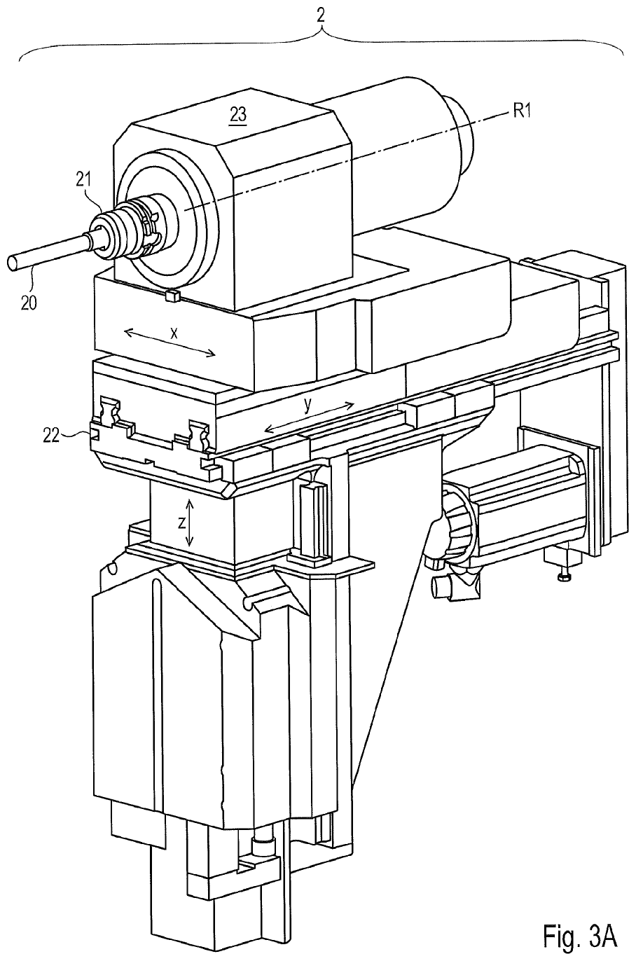

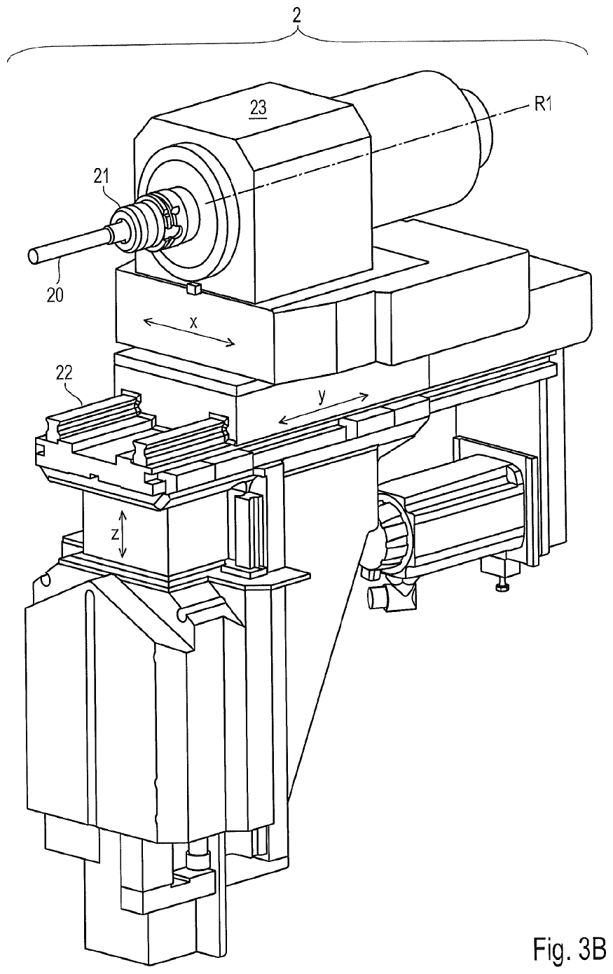

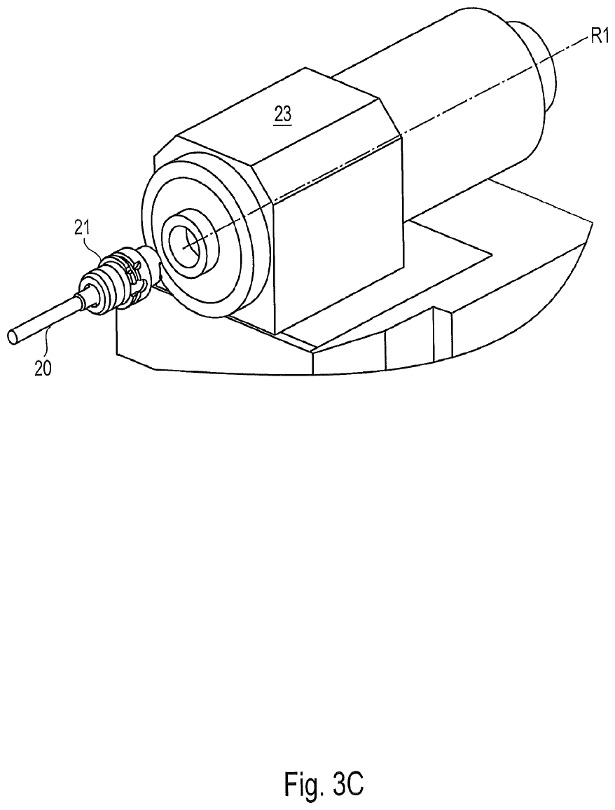

### FIGS. 2A to 2E and 3A to 3C

The machining center 1 illustrated here is designed, for example, for a target value of workpieces to be produced of 200,000 units/year. The machining center comprises three machining units 2 arranged in a star-shape and offset by 90° to one another, with the tools 20 which are clamped in tool holders 21 and which are oriented centrally to the machining region 13. Typical tools 20, which are permanently used or supplied by means of the tool changing unit 5 to the machining units 2, serve for milling, grinding, turning or drilling processes or for thread cutting. At the fourth position, the machining center 1 has a loading and unloading region 3 in which, depending on the current working step, the workpiece 8 is supplied as a blank to the machining region 13, the workpiece is clamped in the machining region 13 during the machining or the workpiece is located in order to be transported away after the machining has been carried out.

The individual machining unit 2 is based on one respective axis system 22 which permits the movement of the tool 20 guided by the machining unit 2 in the x-y-z coordinate system. When the machining spindle 23 is activated it rotates about the first axis of rotation R1, whereby the tool 20, which is driven by the machining spindle 23, is set in rotation. The preferably three machining units 2 can be configured and controlled such that a simultaneous machining takes place on the same workpiece 8.

The loading and unloading region 3 has a pivoting block 4 with a pivoting head 40 which is rotatable about the pivot axis S and on which two clamping chucks 41 are arranged, the clamping chucks serving for holding and transporting the workpieces 8. If the machine concept initially comprises only one machining center 1, one of the clamping chucks 41 of the loading and unloading region 3 is designated for loading and unloading the workpieces 8 in a first rotational position of the pivoting head 40, while the other clamping chuck 41 positions the workpieces 8 for machining in the first rotational position, and in the second rotational position of the pivoting head 40 the functions of the two clamping chucks 41 are changed.

A second axis of rotation R2 also extends through the pivoting block 4 in order to set in rotation, as required, the clamping chuck 41 which is respectively currently located in the axial direction with the workpiece 8 clamped therein, for example for a turning machining process, or to adjust the clamping chuck in terms of rotational position in order to machine another side of the workpiece 8.

However, if the machine concept comprises at least one further machining center 1, due to the requirement of a higher quantity of workpieces 8 to be produced, and the machining steps to be carried out on the workpiece 8 are technologically divided between the plurality of machining centers 1, the clamping chucks 41 of the further machining centers 1 are designated for holding partially machined workpieces 8 to be introduced into the respective machining region 13, or for holding partially machined workpieces 8 to be removed from the respective machining regions 13. The two clamping chucks 41 of the last machining center 1 located in a production line are designated alternately for supplying the partially machined workpieces 8 or for transporting the fully machined workpieces 8 away.

In the context of the machine concept, it is assumed that the production of the workpieces 8 initially takes place with only one machining center 1 according to the recognized validation and, for machine concepts with a plurality of machining centers 1, the validated production conditions continue to apply.

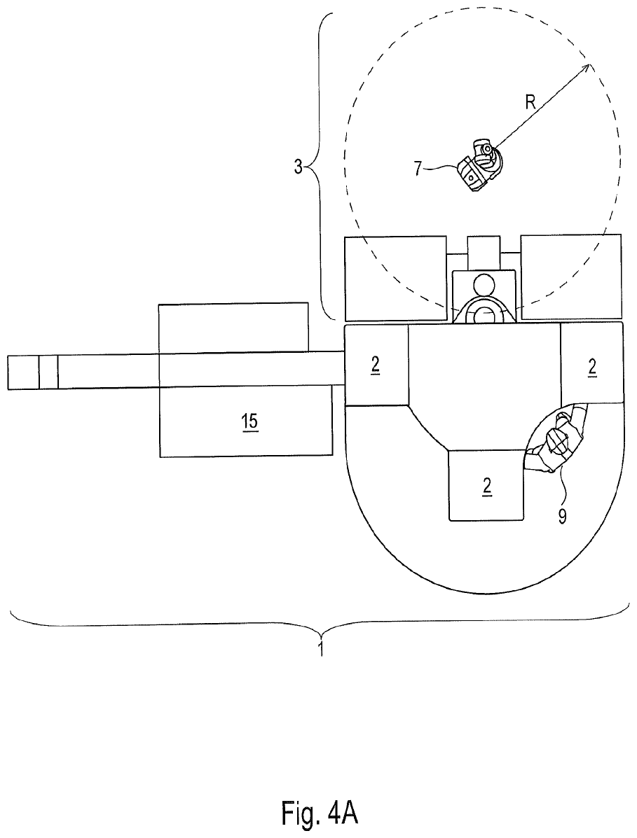

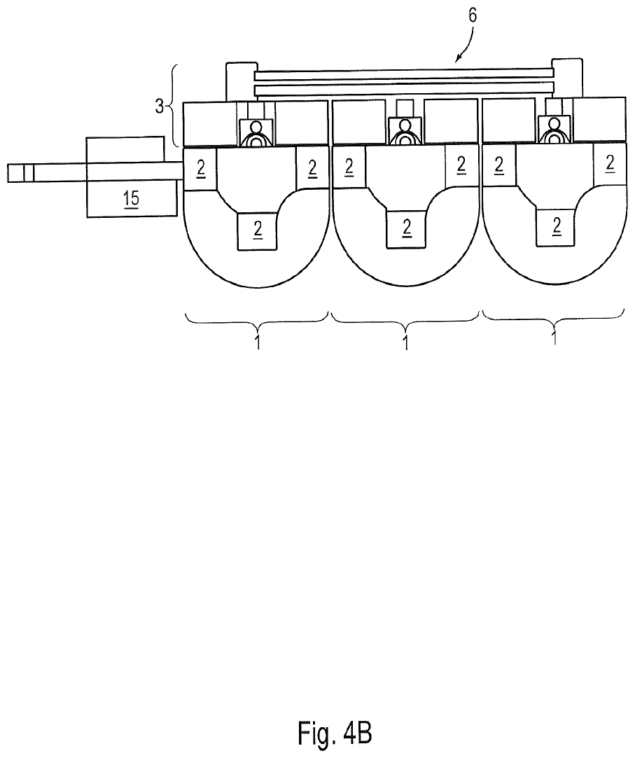

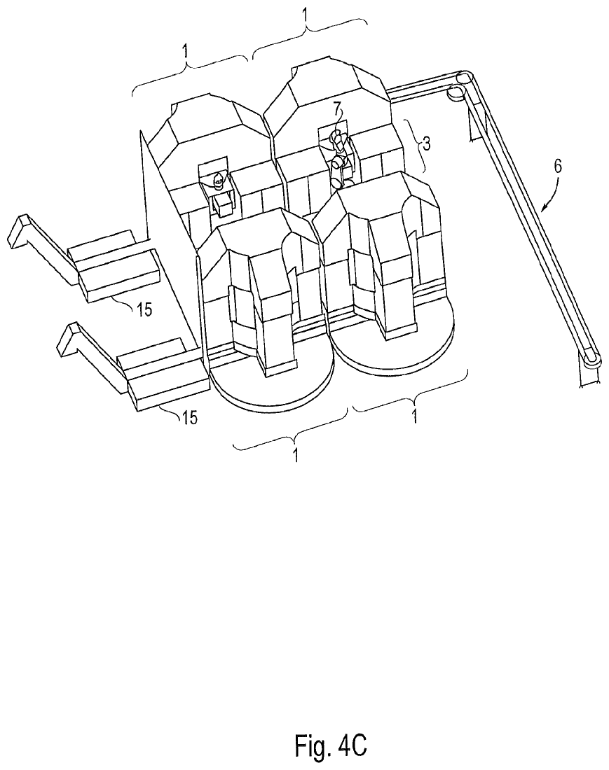

### FIGS. 4A to 4C

With reference to this sequence of figures, machine concepts with extended equipment and a plurality of machining centers 1 are discussed, wherein the recognized validation continues to be maintained.

### FIG. 4A

The one machining center 1 illustrated here is designed, for example, for a target value of workpieces to be produced of 200,000 units/year. A material chips removing region 15 is assigned, in which the material chips arising in the machining of the workpieces 8, including the coolant and lubricant mixed therein, is collected and processed by separation for further use. A robot 7 positioned in the loading and unloading region 3, relative to the machining center 1, with the radius of action R has the functions of loading the machining center 1 comprising the three machining units 2 with workpiece blanks 8 and transporting fully machined workpieces 8 away from the machining center 1, possibly also carrying out further machining or handling steps such as deburring, brushing or palletizing.

### FIG. 4B

This machine concept could be designed, for example, for a target value of workpieces to be produced of 600,000 units/year. For increasing production, three machining centers 1 are provided, linked together in series with the material removing region 15, used as a whole, and the transport device 6. For the technological sequence there are the following alternatives:
all of the machining steps from the workpiece blank 8 to the fully machined workpiece 8 are carried out on each machining center 1; or
the first machining center 1 is designated for carrying out a first sequence of machining steps on the workpiece 8, a second sequence of machining steps takes place on the second machining center 1 and the remining machining steps are carried out on the workpiece 8 on the third machining center 1.

The mixed form of both principles, namely all of the machining steps on one machining center 1 and, in addition and secondarily as it were, dividing the machining steps into two sequences between the two remaining machining centers 1, should only be carried out in a specific configuration.

### FIG. 4C

This machine concept, with four machining centers 1 positioned in a square, could be designed, for example, for a target value of workpieces 8 to be produced of 800,000 units/year. At least one robot 7 is provided for all four machining centers 1, each two adjacent machining centers 1 being connected in each case to one material chips removing region 15 and all four machining centers 1 using one transport device 6 together. The alternatives are once again available for designing the technological sequence of the production of the workpieces 8, namely all machining steps on one machining center 1, dividing into sequences or mixed forms. The one robot 7 is preferably able to be moved between the four machining centers 1. If the time between the working cycles is too short in order to adjust the location of the robot 7, further robots 7 are assigned to the four machining centers 1.

With an even higher target value of workpieces 8 to be produced of, for example, 1,000,000 units/year, the change of production to a transfer machine with the machining units 2 used hitherto in the machining centers 1, and maintaining all validated production conditions, is economically expedient.

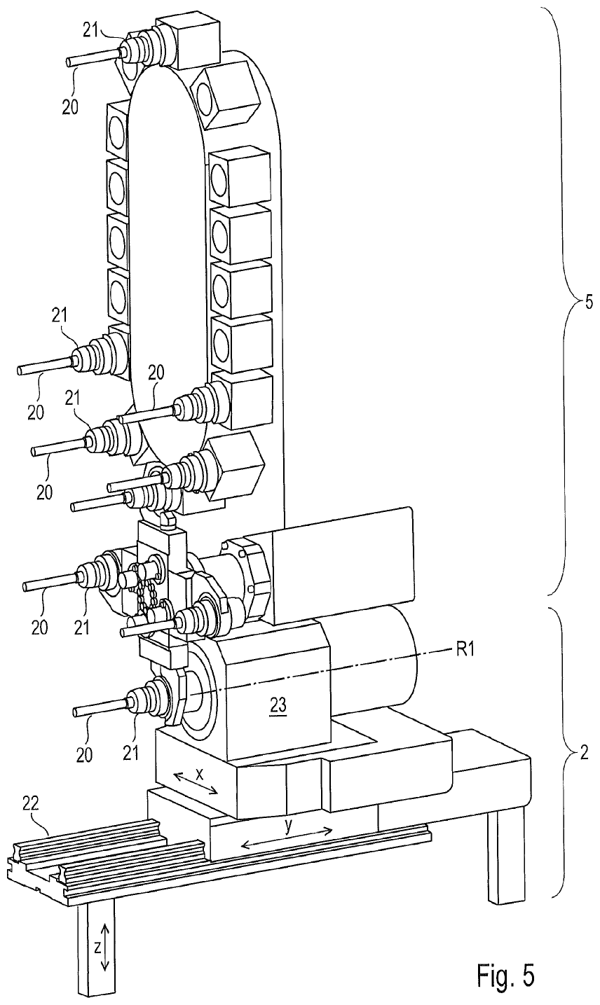

### FIG. 5

In order to permit different machining steps to be able to take place with different tools 20 or a rapid replacement of a worn tool 20 on one machining unit 2, a tool changing unit 5 can be assigned to the machining unit 2. In response to a control command, the tool 20 previously docked on the machining unit 2 is automatically removed by the tool changing unit 5, and a tool 20 which is different or designated as a replacement can be used on the machining unit 2.

1. A machine concept for the mass production of high-precision workpieces, comprising a perspective increase in the quantity of workpieces to be produced within a defined time unit, wherein:
a) in order to produce a first target value of the quantity of workpieces to be produced within the defined time unit according to the machining steps to be carried out on the workpieces, at least one machining center is provided;
b) the machining center is equipped with the required machining units which are directed toward a common machining region;
c) the selection and arrangement of the machining units and technological machining sequence are optimized relative to the workpiece characteristic;
d) these production conditions are fixed as validated after an audit; and
e) in order to produce a second target value of the quantity of workpieces to be produced within the defined time unit, which second target value is increased in relation to the first target value:
ea) at least one further machining center is added to the at least one machining center while maintaining the validated production conditions; or
eb) a transfer machine with the machining units is provided while maintaining the validated production conditions.

2. The machine concept as claimed in claim 1, wherein:
a) the implementation of all of the machining steps to be carried out in a workpiece takes place in the machining region initially of a single machining center under the validated production conditions; or
b) with the continued validity of the validated production conditions, in order to increase the quantity of workpieces to be produced, the machine concept is extended with further machining centers wherein:
ba) all of the machining steps provided on the workpiece are carried out on each individual machining center; or
bb) in a formed production line, the first machining center is designated for carrying out a first sequence of machining steps on the workpiece and the next machining center is designated for carrying out further sequences of machining steps on the workpiece.

3. The machine concept as claimed in claim 1, wherein:
a) when forming a production line with a plurality of machining centers, an interlinked configuration is arranged in series, parallel or combined form; and
b) the individual machining centers, respective groups of machining centers or all of the machining centers are assigned with:
ba) one respective transport device, or one transport device used as a whole, which serves for the supply of the workpiece blanks, for the onward transport of partially machined workpieces and for the removal of the fully machined workpieces;
bb) one respective material chips removing region, or one material chips removing region used as a whole, which serves for the preparation and removal of the material chips which arise; and
bc) could be assigned with a control system which can be used individually or as a whole.

4. The machine concept as claimed in claim 1, wherein a plurality of machining units, preferably three machining units, are provided in the machining region, the machining units being able to be used for simultaneous machining on the same workpiece.

5. The machine concept as claimed in claim 1, wherein:
a) the first machining center has a loading and unloading region for supplying the workpiece blanks into the machining region or for removing the partially or fully machined workpiece; and
b) the at least one next machining center has a loading and unloading region for supplying a workpiece partially machined on an upstream machining center into the machining region of this next machining center or for removing the partially or fully machined workpiece.

6. The machine concept as claimed in claim 1, wherein the individual machining unit with the machining spindle thereof is based on one respective axis system which permits the movement of the tool guided by the machining unit both about the first axis of rotation (R1) and also in the x-y-z coordinate system.

7. The machine concept as claimed in claim 5, wherein the loading and unloading region has a pivoting block with a pivoting head which is rotatable about a pivot axis and which is designated for holding unmachined or partially machined workpieces to be introduced into the machining region or partially or fully machined workpieces to be removed from the machining region.

8. The machine concept as claimed in claim 7, wherein:
a) the pivoting head, which is rotatable about the pivot axis, has at least two clamping chucks for holding and for transporting the workpieces; wherein
b) one of the clamping chucks is designated for loading and unloading the workpieces in a first rotational position of the pivoting head, while the other clamping chuck positions the workpieces for machining in the first rotational position, and in the second rotational position of the pivoting head the functions of the two clamping chucks are changed.

9. The machine concept as claimed in claim 7, wherein a second axis of rotation (R2) extends through the pivoting block in order to set in rotation, as required, the clamping chuck which is respectively currently in the axial direction with the workpiece clamped therein, or to adjust the clamping chuck in terms of rotational position.

10. The machine concept as claimed in claim 1, wherein inside the machining center at least one of the machining units is assigned a tool changing unit.

11. The machine concept as claimed in claim 1, wherein:
a) at least one of the machining units is configured to remove material chips; and
b) one of the machining units could be provided for picking up a workpiece from a clamping chuck.

12. The machine concept as claimed in claim 1, wherein the transfer machine is configured as a rotary transfer machine, a plurality of machining units being installed radially around the centrally arranged rotary frame thereof.
